(19) United States
(12) Patent Application Publication
(10) Pub. No.: US 2026/0042169 A1
(43) Pub. Date: Feb. 12, 2026

(54) LASER TURNING DEVICE, LASER MACHINING DEVICE, AND LASER MACHINING METHOD

(71) Applicant: MITSUBISHI HEAVY INDUSTRIES, LTD., Tokyo (JP)

(72) Inventors: Saneyuki GOYA, Tokyo (JP); Ryuichi NARITA, Tokyo (JP)

(21) Appl. No.: 19/101,251

(22) PCT Filed: Jul. 10, 2023
(86) PCT No.: PCT/JP2023/025437

§ 371 Date: Feb. 5, 2025

(30) Foreign Application Priority Data
Oct. 20, 2022 (JP) 2022-168034

(51) Int. Cl. B23K 26/082; B23K 26/06

(52) U.S. Cl. CPC B23K 26/082; B23K 26/0652

(57) ABSTRACT

Provided is a laser machining device that can facilitate minute control on an incident angle of a laser beam on a dove prism. This laser turning device for turning an incident laser beam comprises: a first wedge prism that deflects the incident laser beam with respect to the optical axis thereof; a dove prism that causes the laser beam having transmitted through the first wedge prism to rotate about the optical axis thereof; a first wedge prism rotating mechanism that causes the first wedge prism to rotate about the optical axis; and a dove prism rotating mechanism that causes the dove prism to rotate about the optical axis.

### TECHNICAL FIELD

The present disclosure relates to a processing device that performs processing by irradiating a work piece with light amplification by stimulated emission of radiation (laser) beam, and particularly relates to an optical system that is suitably used in a laser processing device.

### BACKGROUND ART

A processing device that performs processing on a work piece by performing irradiation with laser beam is widely known. As one form of processing, PTL 1 and PTL 2 disclose a method of perforating the work piece while a circular trajectory is drawn with the laser beam. In PTL 1 and PTL 2, a circular trajectory is drawn by rotating the laser beam by using a Dove prism. In PTL 1 and PTL 2, a wedge prism is used to control the incident angle of the laser beam to the Dove prism. The wedge prism is a prism in which one surface is inclined at a small angle to the other surface, and can deflect light at a small angle.

### CITATION LIST

### Patent Literature

[PTL 1] PCT Japanese Translation Patent Publication No. 2008-543576
[PTL 2] Chinese Utility Model Registration Application No. 213702248 (U)

### SUMMARY OF INVENTION

### Technical Problem

A diameter of the circular trajectory of the laser beam is controlled by the incident angle of the laser beam to the Dove prism. The Dove prism has a feature that the laser beam rotates twice while the Dove prism self-rotates once, and is suitable for high-speed rotation. In PTL 1 and PTL 2, the incident angle is controlled by tilting the wedge prism around the diameter as an axis. However, since the change in the diameter of the trajectory with respect to the change in the incident angle of the laser beam to the Dove prism is large, when the wedge prism is tilted, the change in the diameter of the trajectory with respect to the variation in the tilt angle is large. Therefore, for example, it is necessary to control the incident angle in a minute range of one degree or less with good reproducibility, but in the configuration of related art, it is difficult to control the diameter of the circular trajectory with good reproducibility.

From the above, an object of the present disclosure is to provide a laser processing device in which a small incident angle of laser beam to a tab prism can be easily controlled, and a diameter of a circular trajectory of the laser beam can be controlled with good reproducibility.

### Solution to Problem

A laser turning device that turns incident laser beam of the present disclosure includes a first wedge prism that refracts the incident laser beam with respect to an optical axis, a Dove prism that rotates the laser beam transmitted through the first wedge prism around the optical axis, a first wedge prism rotating mechanism that rotates the first wedge prism around the optical axis, and a Dove prism rotating mechanism that rotates the Dove prism around the optical axis.

A laser processing device according to the present disclosure includes a laser oscillator that outputs laser beam, and an irradiation head that performs irradiation on a work piece while the laser beam is turned.

The irradiation head includes a laser turning unit that turns the laser beam with respect to the work piece, and a focus optical system that focuses the laser beam turned by the laser turning unit.

The laser turning unit includes a first wedge prism that refracts incident laser beam with respect to an optical axis, a Dove prism that rotates the laser beam transmitted through the first wedge prism around the optical axis, a first wedge prism rotating mechanism that rotates the first wedge prism around the optical axis, and a Dove prism rotating mechanism that rotates the Dove prism around the optical axis.

A processing method of the present disclosure of performing a processing treatment in which, by using the laser processing device of the present disclosure, the work piece is irradiated with the laser beam, includes continuously rotating the Dove prism by the Dove prism rotating mechanism during processing of the work piece.

### Advantageous Effects of Invention

According to the present disclosure, a small incident angle of the laser beam to the tab prism can be easily controlled.

### BRIEF DESCRIPTION OF DRAWINGS

FIG. 1 is a view showing a schematic configuration of a laser processing device according to a first embodiment.

FIG. 2 is a diagram describing turning of laser beam.

FIG. 3 is a diagram showing an example of correlation information in which a relative angle θ (degree) of a first wedge prism 41 and a turning radius R are associated with each other.

FIG. 4 is a diagram showing a schematic configuration of a laser processing device according to a second embodiment.

FIG. 5 is a diagram showing a schematic configuration of a laser processing device according to a third embodiment.

FIG. 6 is a diagram showing a schematic configuration of a laser processing device according to a fourth embodiment.

### DESCRIPTION OF EMBODIMENTS

Hereinafter, an embodiment will be described with reference to the accompanying drawings.

### First Embodiment

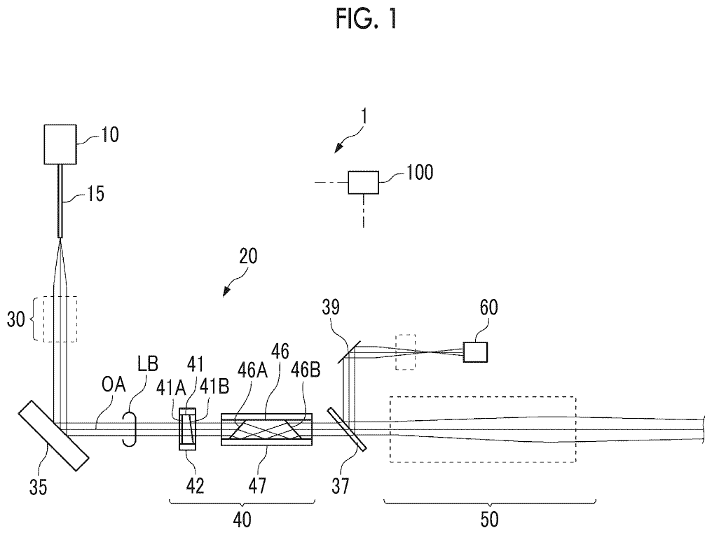

As shown in FIG. 1, a laser processing device 1 includes a laser oscillator 10 that outputs laser beam, and an irradiation head 20 that turns the laser beam output from the laser oscillator 10 and performs irradiation on a work piece W. In addition, the laser processing device 1 includes a controller 100 that controls the operation of the laser oscillator 10 and the irradiation head 20.

An optical fiber as a guide optical system 15 that guides the laser output from the laser oscillator 10 to the irradiation head 20 is provided between the laser oscillator 10 and the irradiation head 20. One end portion of the guide optical system 15 is connected to a laser emission port of the laser oscillator 10, and the other end portion is connected to a laser incident end of the irradiation head 20.

### [Laser Oscillator 10: Referring to FIG. 1]

The laser oscillator 10 is a device that outputs laser beam LB, and, for example, a fiber laser output device that outputs the laser beam LB by using an optical fiber as a medium, a short pulse laser output device that outputs the laser beam LB having a short pulse, or the like is used.

As the fiber laser output device, for example, a Fabry-Perot type fiber laser output device or a ring type fiber laser output device can be used, and the laser beam LB is oscillated by exciting the output devices. As the fiber of the fiber laser output device, for example, silica glass to which a rare earth metal element such as erbium (Er), neodymium (Nd), and ytterbium (Yb) are added can be used.

As the short pulse laser output device, for example, a titanium sapphire laser can be used as an oscillation source of the laser beam LB, and a pulse having a pulse width of 100 picoseconds or less can be oscillated. In addition, the laser beam LB that oscillates a pulse on the order of nanoseconds, such as an yttrium aluminum garnet (YAG) laser or a YVO₄ laser, can also be used.

### [Irradiation Head 20: Refer to FIG. 1]

The irradiation head 20 includes a collimating optical system 30, a laser turning unit 40, a focus optical system 50, and an imaging camera 60. The elements of the irradiation head 20 are disposed in the order of the collimating optical system 30, the laser turning unit 40, and the focus optical system 50 from the upstream side toward the downstream side in the optical path of the laser beam LB output from the guide optical system 15. The irradiation head 20 irradiates the work piece V, which is not shown in FIG. 1, with the laser beam LB output from the guide optical system 15.

### [Collimating Optical System 30: Referring to FIG. 1]

The collimating optical system 30 is disposed to face an end surface from which the laser beam LB of the guide optical system 15 is emitted. That is, the collimating optical system 30 is disposed between the guide optical system 15 and the laser turning unit 40. Although not shown, the collimating optical system 30 includes a plurality of collimating lenses, and uses the laser beam LB output from the guide optical system 15 as collimated light, which is emitted toward the laser turning unit 40 via a first reflective mirror 35. The collimated light is a light beam in which all of the light rays are parallel to all of the other light rays. As an example, a metal mirror having excellent thermal conductivity, such as copper (Cu) or aluminum (Al), is applied as the first reflective mirror 35. On the reflective surface of the metal mirror, surface coating can be performed with gold (Au) or a dielectric multilayer film. The optical system is represented by a rectangular broken line while the description of the lens is omitted.

### [Laser Turning Unit 40: FIGS. 1, 2, and 3]

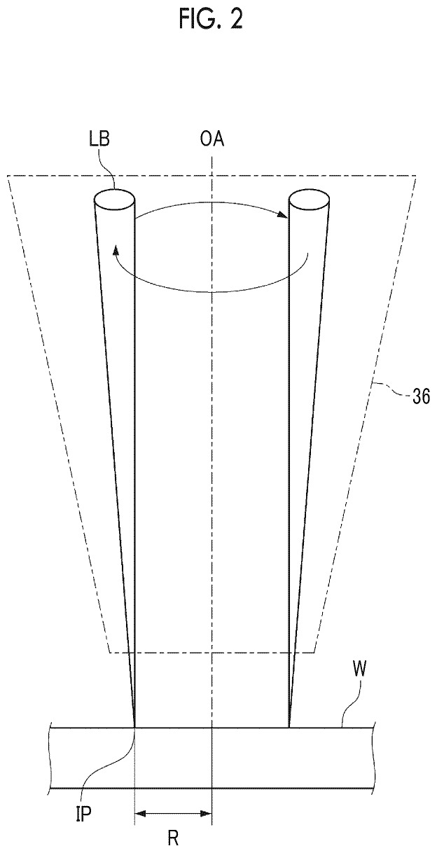

The laser turning unit 40 rotates the laser beam LB around an optical axis OA, which is the center of the laser beam LB, and turns an irradiation position IP of an irradiation laser, that is, the laser beam LB on the work piece W as shown in FIG. 2. The turning radius R is a distance from the optical axis OA to the irradiation position IP of the laser beam LB irradiated on the work piece W as shown in FIG. 2, and refers to a radius with which the laser beam LB irradiated on the work piece W turns around the optical axis OA.

The laser turning unit 40 has a first wedge prism 41, a Dove prism 46, a first wedge prism rotating mechanism 42, and a Dove prism rotating mechanism 47.

### [First Wedge Prism 41]

The first wedge prism 41 refracts the laser beam LB to tilt the laser beam LB with respect to the optical axis OA. The turning radius R can be changed by rotating the first wedge prism 41 around the optical axis OA thereof. That is, the turning radius R required for processing the work piece W can be obtained by controlling the rotation angle (relative angle) around the optical axis OA of the wedge prism 41.

The first wedge prism 41 has an incident surface 41A on which the laser beam LB is incident and an emission surface 41B from which the laser beam LB is emitted. The incident surface 41A is a flat surface orthogonal to the optical axis OA or slightly inclined with respect to the optical axis OA. When the incident surface 41A is inclined, the inclination with respect to the optical axis OA is, for example, less than 1°. That is, when the laser beam LB output from the guide optical system 15 is incident on the incident surface 41A, the laser beam LB reflected by the incident surface 41A can be shifted from the optical axis OA. In this manner, the first wedge prism 41 can suppress the reflected amount of laser reflected from the incident surface 41A toward the guide optical system 15, and can suppress the amount of laser reflected toward the emission port of the laser oscillator 10.

The emission surface 41B is a flat surface having an inclination that refracts the emitted laser beam LB. In this manner, the first wedge prism 41 can tilt the laser beam LB output from the guide optical system 15 with respect to the optical axis OA.

### [First Wedge Prism Rotating Mechanism 42]

The first wedge prism rotating mechanism 42 holds the first wedge prism 41 and rotates the first wedge prism 41 around the optical axis OA. As an example, the first wedge prism rotating mechanism 42 includes a hollow motor having a hollow rotor that holds the first wedge prism 41 and a hollow stator disposed to face the hollow rotor. A hollow spindle can be interposed between the first wedge prism 41 and the first wedge prism rotating mechanism 42. The same applies to the Dove prism rotating mechanism 47.

In addition, the first wedge prism rotating mechanism 42 can include an encoder that detects a relative position and a rotation speed between a rotation unit (hollow rotor) and a fixed unit (hollow stator). The encoder has an identifier that is fixed to a side of the rotation unit, and a detecting unit that is fixed to a side of the fixed unit and detects the identifier. The encoder can detect the relative position (angle) of the rotation unit by detecting the identifier by the detecting unit. The encoder outputs information about the rotation speed and the rotation position (phase angle) of the detected rotation unit to the control device. In addition, as the encoder, for example, it is preferable to use a detection device that detects a rotation position (phase angle) with a resolution of one thousandth of a degree (0.001 degrees or less). The same encoder can be provided for the Dove prism rotating mechanism 47.

### [Dove Prism 46]

The Dove prism 46 has a shape in which both ends of a quadrangular column are obliquely cut, a vertical cross surface thereof has an isosceles trapezoidal shape, and the inclined surfaces of the both ends are symmetrical with respect to a surface perpendicular to the optical axis OA of the incident light. Since the laser beam LB transmitted through the Dove prism 46 is emitted after being inverted, when a rotation is made by a certain angle around the optical axis OA of the incident light, the emitted light has the property of rotating by twice the rotation angle around the optical axis OA thereof.

The Dove prism 46 has an incident surface 46A on which the laser beam LB is incident and an emission surface 46B from which the laser beam LB is emitted. When the laser beam LB is incident on the incident surface 46A of the Dove prism 46 at a specific angle, the laser beam LB can draw two concentric circles having the same diameter, that is, having the turning radius R, while the Dove prism 46 rotates once.

### [Dove Prism Rotating Mechanism 47]

The Dove prism rotating mechanism 47 holds the Dove prism 46 and performs rotation around the optical axis OA. It is sufficient that the Dove prism rotating mechanism 47 only has a configuration similar to that of the first wedge prism rotating mechanism 42.

### [Focus Optical System 50: FIG. 1]

The focus optical system 50 has a plurality of lenses (not shown), and the plurality of lenses focus the laser beam LB irradiated from the laser turning unit 40 to form the laser beam LB having a predetermined focal length and a predetermined focal depth. The focus optical system 50 irradiates the work piece W with the laser beam LB having a predetermined spot diameter.

The laser beam LB output from the laser turning unit 40 is reflected by a second reflective mirror 37 and a third reflective mirror 39. The second reflective mirror 37 is a half mirror. The second reflective mirror 37 transmits the laser beam LB received from the laser turning unit 40 toward the focus optical system 50, and performs reflection toward the third reflective mirror 39. The imaging camera 60 can image the processing portion of the work piece W by the laser beam LB reflected by the third reflective mirror 39.

### [Imaging Camera 60: FIG. 1]

The imaging camera 60 is, for example, a camera having a charge coupled device (CCD) image sensor or the like. The imaging camera 60 images the irradiation position IP and the turning radius R of the laser beam LB, or the like, generates image data from the captured image, and outputs the image data to the controller 100. The imaging camera 60 is disposed coaxially with the optical axis OA.

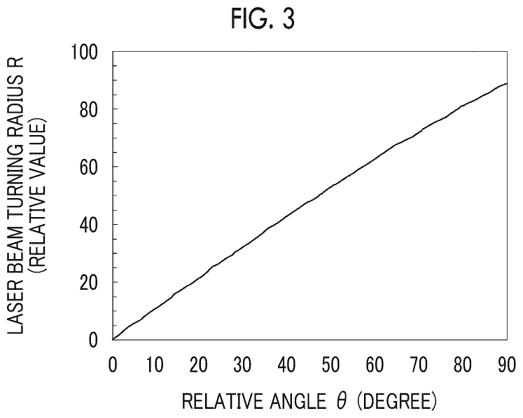

### [Controller 100: FIGS. 1 and 3]

The controller 100 is connected to the laser oscillator 10 and the irradiation head 20 and controls the operation of each unit. The controller 100, for example, controls various conditions of the laser output from the laser oscillator 10, or controls the operation of the moving mechanism of the irradiation head 20 (not shown) to adjust the position of the irradiation head 20 with respect to the work piece Wv. In addition, the controller 100 detects and sets an allowable thickness of a heat-affected layer from a specification (material, thickness, or the like) of the work piece W or a condition of the processing treatment, or controls the turning radius R of the laser beam LB irradiated from the irradiation head 20 to the work piece W.

The controller 100 holds correlation information in which a relative angle θ (degree) of the first wedge prism 41 and the turning radius R are associated with each other, to control the turning radius R. FIG. 3 is an example thereof, and the example shows a range of the relative angle θ from 0 degrees to 90 degrees. As is clear from the correlation information shown in FIG. 3, any turning radius R can be set with high accuracy by rotating the first wedge prism 41.

### [Processing Procedure]

An example of a procedure for processing the work piece WV by using the laser processing device 1 will be described.

### STEP 1: Setting of Turning Radius Rn and Relative Angle θn

Prior to the laser processing, for example, a specific turning radius Rn required for processing the work piece W is input to the controller 100. The controller 100 specifies the relative angle θn of the first wedge prism 41 required for processing the turning radius Rn by comparing the input turning radius Rn with the correlation information shown in FIG. 3. When the relative angle θn is specified, the controller 100 rotationally drives the first wedge prism rotating mechanism 42 such that the first wedge prism 41 is at the relative angle θn.

### STEP 2: Rotation of Dove Prism 46

After the first wedge prism 41 is operated to have the relative angle θn, the controller 100 rotates the Dove prism 46 by rotationally driving the Dove prism rotating mechanism 47.

As a result of the above-described STEP 1 and STEP 2, a prerequisite condition is established to perform processing with the circular trajectory having the required turning radius Rn. Here, an example in which STEP 2 is performed after STEP 1 has been described, but STEP 1 may be performed after STEP 2, or STEP 1 and STEP 2 may be performed simultaneously and in parallel.

### STEP 3: Output of Laser Beam LB, Processing of Work Piece W

Next, the controller 100 operates the laser oscillator 10 to output the laser beam LB from the laser oscillator 10. The laser beam LB output from the laser oscillator 10 passes through the irradiation head 20 and is irradiated to the work piece W. As shown in FIG. 2, while the laser bean LB rotates around the optical axis OA with the turning radius Rn, the work piece W is processed, for example, cut, in a circular shape. During the processing, the irradiation head 20 can be moved or the work piece W can be moved by a drive system (not shown).

In the processing procedure described above, it is assumed that the turning radius Rn is constant during the processing, but the turning radius Rn can be changed to, for example, the turning radiuses R1, R2, and R3 during the processing. In this case, the turning radiuses R1, R2, and R3 are input to the controller 100 in advance. When the processing is started at the turning radius R1, a timing at which the turning radius R1 is changed to the turning radius R2 and a timing at which the turning radius R2 is changed to the turning radius R3 are also input to the controller 100.

### Effects of First Embodiment

In the laser processing device 1, the laser turning unit 40 disposes the first wedge prism 41 in front of the Dove prism 46 and controls an incident angle cp of the laser beam LB on the Dove prism 46 by controlling the relative angle, that is, the phase, of the first wedge prism 41. Therefore, the incident angle φ of the laser beam LB with respect to the Dove prism 46 can be set with high accuracy as compared to the case where the wedge prism 41 is tilted with respect to the optical axis OA.

The incident angle φ of the laser beam LB with respect to the Dove prism 46 is, for example, as small as about 1 degree, so that the deviation amount of the incident angle φ with respect to the Dove prism 46 is expressed by the following expression.

Deviation amount=incident angleφ×L1
L1=a distance between the first wedge prism 41 and the Dove prism 46

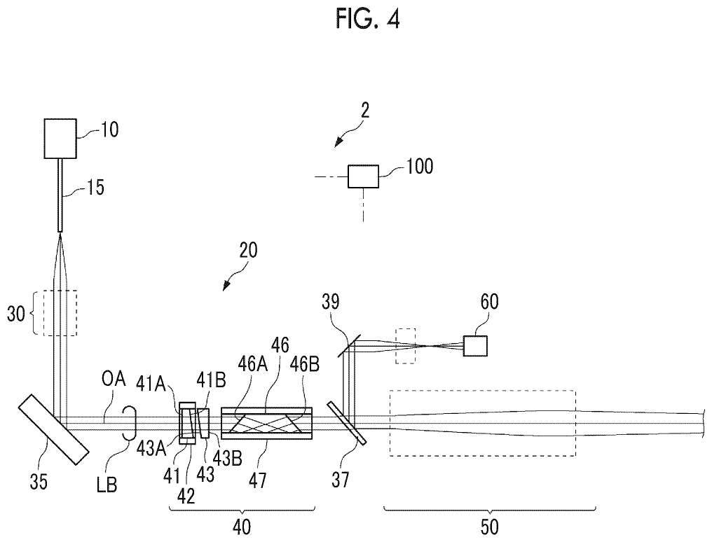

### Second Embodiment: Referring to FIG. 4

Next, a laser processing device 2 according to a second embodiment will be described.

As shown in FIG. 4, the laser processing device 2 is provided with a second wedge prism 43 between the first wedge prism 41 and the Dove prism 46. By providing the second wedge prism 43, the laser processing device 2 can control the incident angle φ of the laser beam LB with respect to the Dove prism 46 with higher accuracy than the laser processing device 1. The first wedge prism 41 can be rotated by the first wedge prism rotating mechanism 42, while the second wedge prism 43 cannot be rotated around the optical axis OA and is fixed.

The second wedge prism 43 has an incident surface 43A on which the laser beam LB is incident and an emission surface 43B from which the laser beam LB is emitted.

The incident surface 43A is a flat surface having an inclination that refracts the laser beam LB output from the first wedge prism 41. In this manner, the second wedge prism 43 refracts the laser beam LB refracted by the first wedge prism 41 again.

The emission surface 43B is a flat surface orthogonal to or slightly inclined with respect to the optical axis OA of the laser beam LB refracted at the incident surface 43A. When the emission surface 43B is inclined, the inclination of the laser beam LB, which is refracted at the incident surface 43A, with respect to the optical axis is, for example, less than 1°. In this way, when the laser beam LB output from the first wedge prism 41 is emitted, the emission surface 43B can shift the laser beam LB reflected on the emission surface 43B from the optical axis of the laser beam LB refracted on the incident surface 43A.

### [Effect of Laser Processing Device 2]

The laser processing device 2 includes the second wedge prism 43 in addition to the first wedge prism 41. Here, when two sets of wedge prisms are controlled as compared to the case where only one set of wedge prisms is controlled, the angle range to be controlled by each wedge prism may be halved. Therefore, according to the laser processing device 2, the incident angle φ of the laser beam LB with respect to the Dove prism 46 can be controlled with an accuracy that is twice that of the first embodiment.

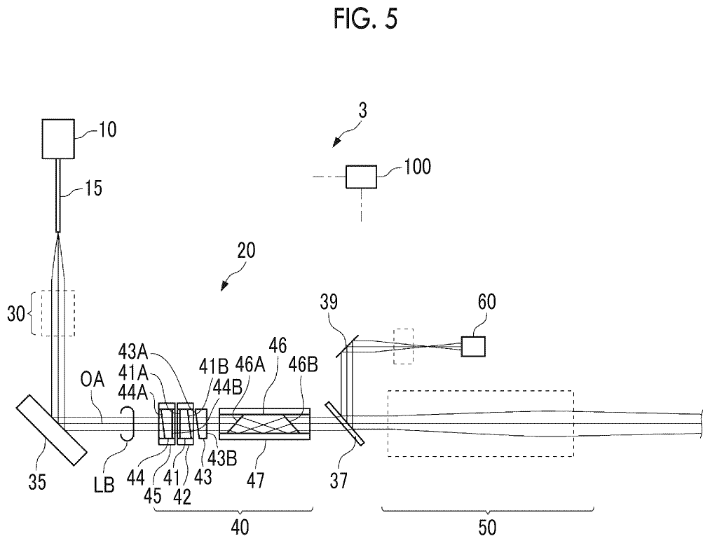

### Third Embodiment: Referring to FIG. 5

Next, a laser processing device 3 according to a third embodiment will be described.

As shown in FIG. 5, the laser processing device 3 is further provided with a third wedge prism 44 to face the first wedge prism 41 in addition to the laser processing device 2 according to the second embodiment.

The third wedge prism 44 has the same specifications as the first wedge prism 41 including being rotatable, and refracts the laser beam LB to be emitted toward the first wedge prism 41 while being tilted with respect to the optical axis OA. The incident angle φ of the laser beam LB with respect to the Dove prism 46 by the laser processing device 3 is a value obtained by summing an incident angle φ1 by the first wedge prism 41 and an incident angle φ2 by the third wedge prism 44.

### [Effect of Laser Processing Device 3]

The laser processing device 3 has the following effects in addition to the effects of the laser processing device 2.

The incident angle φ of the laser beam LB with respect to the Dove prism 46 by the laser processing device 3 is a value obtained by summing an incident angle φ1 by the first wedge prism 41 and an incident angle φ2 by the third wedge prism 44. Therefore, according to the laser processing device 3, the turning radius R of the laser beam LB during processing of the work piece W can be increased.

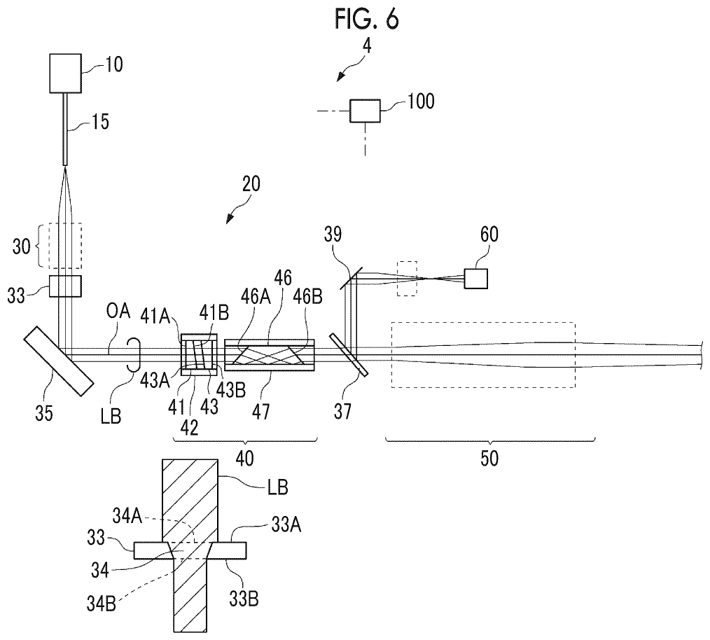

### Fourth Embodiment: Referring to FIG. 6

Next, a laser processing device 4 according to a fourth embodiment will be described.

The laser processing device 4 includes an aperture 33 between the collimating optical system 30 and the first wedge prism 41. The basic configuration of the laser processing device 4 shown in FIG. 6 follows the laser processing device 2 as an example, but the aperture 33 can also be provided in the laser processing device 1 or the laser processing device 3.

The aperture 33 has a front surface 33A and a rear surface 33B, and includes a light transmission path 34 having a circular outer shape that penetrates the front surface 33A and the rear surface 33B. An incident port 34A is provided on a side of the front surface 33A of the light transmission path 34, and an emission port 34B of the laser beam LB is provided on a side of the rear surface 33B. The opening diameter of the light transmission path 34 of the aperture 33 is continuously reduced from the incident port 34A toward the emission port 34B, and the light transmission path 34 is surrounded by a tapered conical inclined surface.

When the laser beam LB is irradiated toward the incident port 34A of the aperture 33 and the beam diameter of the laser beam LB is larger than the opening diameter of the incident port 34A, the peripheral edge of the laser beam LB, that is, a skirt portion of the beam energy profile is irradiated to the front surface 33A at the peripheral edge of the incident port 34A, and is blocked by the aperture 33. When the beam diameter of the laser beam LB is equal to or smaller than the opening diameter of the incident port 34A, the laser beam LB transmits through the light transmission path 34. The temperature of the aperture 33 rises since the laser beam LB irradiated to the front surface 33A is absorbed by the aperture 33, so that it is preferable that a cooling structure such as water cooling is provided for the aperture 33.

As described above, the aperture 33 can control the beam diameter of the collimated light that is the laser beam LB output from the collimating optical system 30, and can suppress interference of the laser beam entering the wedge prism or the Dove prism in the subsequent stage with an unnecessary portion. As a specific example of preferable control, energy equivalent to 99% of the laser beam LB defined by the following expression (1) is transmitted, but the peripheral edge of the beam equivalent to 1% is blocked.

$$( 1 / {e}^{2} : Gaussian beam diameter ) \times 1.5 \qquad Expression ( 1 )$$

### [Effect of Laser Processing Device 4]

The laser processing device 4 including the aperture 33 can prevent the temperature of the Dove prism 46 from rising.

The Dove prism 46 can be rotated by the Dove prism rotating mechanism 47. For example, when the opening diameter (inner diameter) of the spindle of the Dove prism rotating mechanism 47 is small, the spindle is irradiated with the peripheral edge portion of the laser beam LB, and the spindle generates heat. In this case, there is a risk that the Dove prism 46 is heated via a member such as a holder that holds the spindle and the Dove prism 46.

However, the laser processing device 4 can control the beam diameter of the laser beam LB to be smaller than the inner diameter of the spindle by the aperture 33, so that the heating of the Dove prism 46 can be suppressed.

In addition, the aperture 33 forms a tapered conical inclined surface around the light transmission path 34. Therefore, the laser beam LB reflected by the inclined surface is deviated from the optical axis OA and does not return to the laser oscillator 10, so that the laser oscillator 10 can be suppressed from being damaged.

In addition to the above, it is possible to select the configurations described in the embodiment described above or to change the configurations to other configurations as appropriate.

Various materials such as a metallic material, a ceramic material, and a resin material are applied to the work piece W in the present disclosure.

Examples of the metallic material include Fe-based alloys such as carbon steel, heat-resistant steel, and stainless steel. Ni-based alloys such as superalloys and magnetic alloys, and titanium alloys.

Examples of the ceramic material include zirconium-based ceramics such as ZrO₂ and silicon nitride-based ceramics such as Si₃N₄.

Examples of the resin material include fiber reinforced plastics such as carbon fiber reinforced plastics (CFRP), glass fiber reinforced plastics (GFRP), and glass-mat reinforced thermoplastics (GMT).

In addition, the processing treatment corresponds to any type of cutting processing, drilling processing, welding processing, cladding processing, surface modification processing, surface finishing processing, and laser additive manufacturing, and these processing can be combined. The form of the work piece W is optional, but typically, a plate member is targeted.

### APPENDIX

### <Additional Note 1>

A laser turning device (40) that turns incident laser beam (LB) includes a first wedge prism (41) that refracts the incident laser beam (LB) with respect to an optical axis (OA), a Dove prism (46) that rotates the laser beam (LB) transmitted through the first wedge prism (41) around the optical axis (OA), a first wedge prism rotating mechanism (42) that rotates the first wedge prism (41) around the optical axis (OA), and a Dove prism rotating mechanism (47) that rotates the Dove prism (46) around the optical axis (OA).

### <Additional Note 2>

In Additional Note 1, preferably, a second wedge prism (43) that is provided between the first wedge prism (41) and the Dove prism (46) and that refracts the incident laser beam (LB) with respect to the optical axis (OA) is further provided, in which rotation of the second wedge prism (43) around the optical axis (OA) is fixed.

According to Additional Note 2, the incident angle φ of the laser beam LB with respect to the Dove prism 46 can be set with higher accuracy.

### <Additional Note 3>

In Additional Note 1 or Additional Note 2, preferably, a third wedge prism (44) that is provided on a front side of the first wedge prism (41) on which the laser beam (LB) is incident and that refracts the incident laser beam (LB) with respect to the optical axis (OA), and a third wedge prism rotating mechanism (45) that rotates the third wedge prism (44) around the optical axis (OA) are further provided.

According to Additional Note 3, the third wedge prism (44) is added, so that the turning radius R of the laser beam LB during processing of the work piece W can be increased.

### <Additional Note 4>

A laser processing device (1, 2, 3, and 4) includes a laser oscillator (10) that outputs laser beam (LB), and an irradiation head (20) that performs irradiation on a work piece (W) while the laser beam (LB) is turned.

The irradiation head (20) includes a laser turning unit (40) that turns the laser beam (LB) with respect to the work piece (W), and a focus optical system (50) that focuses the laser beam (LB) turned by the laser turning unit (40).

The laser turning unit (40) includes a first wedge prism (41) that refracts incident laser beam (LB) with respect to an optical axis (OA), a Dove prism (46) that rotates the laser beam (LB) transmitted through the first wedge prism (41) around the optical axis (OA), a first wedge prism rotating mechanism (42) that rotates the first wedge prism (41) around the optical axis (OA), and a Dove prism rotating mechanism (47) that rotates the Dove prism (46) around the optical axis (OA).

### <Additional Note 5>

In Additional Note 4, preferably, the laser turning unit (40) includes a second wedge prism (43) that is provided between the first wedge prism (41) and the Dove prism (46) and that refracts the incident laser beam (LB) with respect to the optical axis (OA), and the second wedge prism (43) is not rotatable around the optical axis (OA).

### <Additional Note 6>

In Additional Note 5, preferably, the laser turning unit (40) includes a third wedge prism (44) that is provided on a front side of the first wedge prism (41) on which the laser beam (LB) is incident and that refracts the incident laser beam (LB) with respect to the optical axis (OA), and a third wedge prism rotating mechanism (45) that rotates the third wedge prism (44) around the optical axis (OA).

### <Additional Note 7>

In Additional Note 5 or Additional Note 6, preferably, an aperture (33) that blocks a portion of the laser beam (LB) output from the laser oscillator (10) to emit the laser beam (LB) toward the irradiation head (20) is further provided.

The beam diameter of the laser beam LB can be set by the aperture 33, and the heating of the Dove prism 46 can be suppressed.

### <Additional Note 8>

A processing method of performing a processing treatment in which, by using the laser processing device according to any one of Additional Note 4 to Additional Note 7, the work piece (W) is irradiated with the laser beam (LB), includes continuously rotating the Dove prism (46) by the Dove prism rotating mechanism (47) during processing of the work piece (W).

### <Additional Note 9>

In Additional Note 8, preferably, the first wedge prism (41) is set to a predetermined relative angle by the first wedge prism rotating mechanism (42) prior to processing the work piece (W), and the first wedge prism (41) is maintained at the predetermined relative angle during processing of the work piece (W).

### <Additional Note 10>

In Additional Note 8 or Additional Note 9, preferably, the laser beam (LB) irradiated to the work piece (W) is turned with a predetermined turning radius R, and the predetermined relative angle is set based on correlation information in which the relative angle of the first wedge prism (41) and the turning radius are associated with each other.

### REFERENCE SIGNS LIST

1, 2, 3, and 4: Laser processing device
10: Laser oscillator
15: Guide optical system
20: Irradiation head
30: Collimating optical system
33: Aperture
33A: Front surface
33B: Rear surface
34: Light transmission path
34A: Incident port
34B: Emission port
35: First reflective mirror
37: Second reflective mirror
39: Third reflective mirror
40: Laser turning unit
41: First wedge prism (rotation)
41A: Incident surface
41B: Emission surface
42: First wedge prism rotating mechanism
43: Second wedge prism (fixed)
43A: Incident surface
43B: Emission surface
44: Third wedge prism (rotation)
44A: Incident surface
44B: Emission surface
45: Third wedge prism rotating mechanism
46: Dove prism
46A: Incident surface
46B: Emission surface
47: Dove prism rotating mechanism
50: Focus optical system
60: Imaging camera
100: Controller
LB: Laser beam
OA: Optical axis
IP: Irradiation position
R: Turning radius
W: Work piece

1. A laser turning device that turns incident laser beam, the device comprising:
a first wedge prism that refracts the incident laser beam with respect to an optical axis;
a Dove prism that rotates the laser beam transmitted through the first wedge prism around the optical axis;
a first wedge prism rotating mechanism that rotates the first wedge prism around the optical axis; and
a Dove prism rotating mechanism that rotates the Dove prism around the optical axis.

2. The laser turning device according to claim 1, further comprising:
a second wedge prism that is provided between the first wedge prism and the Dove prism and that refracts the incident laser beam with respect to the optical axis, wherein
the second wedge prism is not rotatable around the optical axis.

3. The laser turning device according to claim 1, further comprising:
a third wedge prism that is provided on a front side of the first wedge prism on which the laser beam is incident and that refracts the incident laser beam with respect to the optical axis; and
a third wedge prism rotating mechanism that rotates the third wedge prism around the optical axis.

4. A laser processing device comprising:
a laser oscillator that outputs laser beam; and
an irradiation head that performs irradiation on a work piece while the laser beam is turned, wherein
the irradiation head includes
a laser turning unit that turns the laser beam with respect to the work piece, and
a focus optical system that focuses the laser beam turned by the laser turning unit, and
the laser turning unit includes
a first wedge prism that refracts incident laser beam with respect to an optical axis,
a Dove prism that rotates the laser beam transmitted through the first wedge prism around the optical axis,
a first wedge prism rotating mechanism that rotates the first wedge prism around the optical axis, and
a Dove prism rotating mechanism that rotates the Dove prism around the optical axis.

5. The laser processing device according to claim 4, wherein
the laser turning unit includes
a second wedge prism that is provided between the first wedge prism and the Dove prism and that refracts the incident laser beam with respect to the optical axis, and
the second wedge prism is not rotatable around the optical axis.

6. The laser processing device according to claim 4, wherein
the laser turning unit includes
a third wedge prism that is provided on a front side of the first wedge prism on which the laser beam is incident and that refracts the incident laser beam with respect to the optical axis, and
a third wedge prism rotating mechanism that rotates the third wedge prism around the optical axis.

7. The laser processing device according to claim 4, further comprising:
an aperture that blocks a skirt portion of the laser beam output from the laser oscillator to emit the laser beam toward the irradiation head.

8. A processing method of performing a processing treatment in which, by using the laser processing device according to claim 4, the work piece is irradiated with the laser beam, the processing method comprising:
continuously rotating the Dove prism by the Dove prism rotating mechanism during processing of the work piece.

9. The processing method according to claim 8, wherein
the first wedge prism is set to a predetermined relative angle by the first wedge prism rotating mechanism prior to processing the work piece, and
the first wedge prism is maintained at the predetermined relative angle during processing of the work piece.

10. The processing method according to claim 9, wherein
the laser beam irradiated to the work piece is turned with a predetermined turning radius, and
the predetermined relative angle is set based on correlation information in which the relative angle of the first wedge prism and the turning radius are associated with each other.
